(19) United States
(12) Patent Application Publication
(10) Pub. No.: US 2004/0255674 A1
(43) Pub. Date: Dec. 23, 2004

(54) Control device in a vehicle and sensor

(76) Inventors: Eckard Steiger, Stuttgart (DE); Hartmut Schumacher, Freiburg (DE)

Correspondence Address: Striker Striker & Stenby, 103 East Neck Road, Huntington, NY, 11743, US

(21) Appl. No.: 10/492,996

(22) PCT Filed: Feb. 13, 2003
(86) PCT No.: PCT/DE03/00428

(30) Foreign Application Priority Data
May 25, 2002 (DE) 102-23-364.0

(51) Int. Cl. G01P 15/125

(52) U.S. Cl. 73/514.32

(57) ABSTRACT

A control unit in a vehicle with a processor and a sensor is proposed, whereby the processor is capable of being connected with the sensor, whereby the processor includes means for generating at least one clock pulse for the at least one sensor, whereby the sensor uses the clock pulse for a sensor operation, preferably sensor measurement and sensor signal processing.

### BACKGROUND INFORMATION

The present invention is based on a control unit in a vehicle, and a sensor, according to the general class of the independent claims.

### ADVANTAGES OF THE INVENTION

The control unit according to the invention, in a vehicle, and the sensor according to the invention, have the advantage that the clock cycle for the connected sensors is now generated centrally by a processor in the control unit, the clock cycle being used for sensor operation, and preferably for sensor measurement. This reduces the complexity of the circuitry, because separate means for clock-cycle generation therefore need not be assigned to each sensor, i.e., an oscillator inside each sensor, for example. Instead, the centrally located means for clock-cycle generation can also be designed more exactly in terms of reliability and frequency acuteness, due to generally higher requirements on the overall system clock cycle. More exact triggering times are therefore achieved with restraining systems, in particular, in which this control unit and the sensor are used, because the acuteness of adjustment is improved, the acuteness of adjustment being dependent on the tolerance of the sensor values. Above all, this enables easier application with various crash types and vehicle types. Accuracies of <10⁴% can be achieved as a result, particularly when a quartz oscillator is used. A centrally located ceramic resonator also has lower tolerance, typically <0.3%. These accuracies allow tolerance windows of an output filter edge frequency to be limited to approximately <5%. The measurement accuracy of the sensor is increased as a result, which, in turn, enables easier application in vehicle restraining systems. The control unit according to the invention and the sensor according to the invention can be used not only in restraining systems, but also in other automotive applications. One example is the electronic stability program.

Advantageous improvements of the control unit and the sensor indicated in the independent claims are possible due to the measures and further developments listed in the dependent claims.

It is particularly advantageous that the means for generating the at least one clock cycle includes an oscillation generation circuit, means for frequency multiplication, and first means for pulse division. The clock cycle required for the individual sensors or sensor groups can therefore be derived from the centrally generated oscillation. This is carried out preferably digitally. The oscillation generation circuit includes a quartz oscillator or a ceramic resonator. A phase-locked loop is typically used as the means for frequency multiplication. The first means for pulse division include a prescaler with at least one register, whereby the at least one register has the particular dividing ratio. If three different clock cycles are required for different sensors, for example, then three registers are needed to create the corresponding keying ratios.

The processor, which provides these different clock cycles, advantageously also includes means for providing different levels for the timing signals. Different signals may need different input signals, so levels of this nature should then be provided.

The sensor according to the invention advantageously includes means for pulse division and phase mode generation, which serve to prepare timing signals inside the sensor. “Phase mode generation” means that every consecutive timing signals is not used, but, instead, only every second one, every fourth one, etc. This is necessary with micromechanical sensors, in particular, which function according to the principle of differential capacitance, to perform measurement operations.

In general, a dedicated clock cycle line is necessary for the sensor according to the invention. That is, two clock cycles—the clock cycle that applies to the invention, and the interface clock cycle—are supplied to sensors with a synchronous digital interface. It is also possible in this case, however, to design the sensor according to the invention in such a manner that the interface clock pulse also serves as the basis for the measurement and signal processing function. An additional clock cycle line is then eliminated entirely.

The sensor that is connected with the processor can be located in the control unit or outside of the control unit. A connection using a unidirectional or bidirectional data line is possible in this case. A bus connection between the processor and the sensor is also possible in this case, although it should be noted that the clock cycle that is transferred from the processor to the sensor serves to process the measurement signals in the sensor and not to transfer data.

The clock cycle lines that lead from the processor to the sensors are connected at corresponding pins of the sensors.

### DRAWING

Exemplary embodiments of the invention are presented in the drawing, and they are explained in greater detail in the subsequent description.

FIG. 1 shows a first configuration of the control unit and the sensors,

FIG. 2 shows a second configuration of the control unit and the sensors,

FIG. 3 shows a block diagram of clock extraction in the processor,

FIG. 4 shows a block diagram of signal processing in the sensor,

FIG. 5 shows measurement electrodes for connection to a sensor element,

FIG. 6 shows phase mode generation.

### DESCRIPTION

In the case of electronics for restraining systems, the clock cycle required to operate the sensor is typically generated exclusively, i.e., a dedicated oscillator is associated with each sensor to generate the clock cycle. Generally, an oscillator is integrated in the sensor evaluation IC. This sensor ASIC performs the functions of signal sampling, measurement, preparation and preprocessing, e.g., filtering or offset compensation. Typically, “RC-on-chip” oscillators with oscillation frequencies in the range from one to many hundreds of kilohertz are used. The timing signal and the clock cycles derived therefrom are required for clock-pulse controlled signal measurement, for filtering, offset regulation, etc.

The realization of an oscillator for each sensor, and the circuitry and frequency adjusting structures required for the oscillator requires complex circuitry and, therefore, costs. Furthermore, for reasons of cost and producibility, the oscillator circuit is generally realized in the semiconductor processes that are used as an RC oscillator that is relatively inexact in terms of frequency acuteness. Tolerances of approximately 10% in terms of scattering, adjustment accuracy, temperature and service life must therefore be taken into account. In the sensor application, this inexactitude of the time base acts across a correspondingly great tolerance window of the output filter characteristics, tolerance of the edge frequency typically ±20%. The edge frequency tolerance, in particular, applies directly to the acuteness of adjustment of the restraining system triggering times. An application to various crash and vehicle types is made correspondingly difficult and inexact.

According to the invention, the clock cycle for the connected sensors and, in fact, for their operation and, in particular, measurement, is now generated centrally in a control unit. The individual oscillator circuits in the individual sensors can therefore be eliminated. “Typical” sensors in this case refer to acceleration sensors and yaw-rate sensors. However, pressure and temperature sensors are also capable of being used for this invention, because all of these sensors share the common feature of generating and preprocessing measured signals in one measurement cycle.

FIG. 1 shows a first basic configuration of a control unit 5 and connected sensors 3 and 4. Sensors 3 and 4 are located outside control unit 5. For simplicity, only one processor 1 and one memory 2 connected via a data input and output are shown in control unit 5. Further components are contained in control unit 5, of course. Sensors 3 and 4 are connected with processor 1 via a data line 6. Using means for clock-cycle generation, processor 1 centrally generates the clock cycle for sensors 4 and 3, via a suitable interface PC, if necessary. With this clock cycle, sensors 3 and 4 perform their measurement and preprocessing of these measured values. Data line 6 can be configured as a bus, or separate data lines can be provided for each of the sensors 3 and 4. Only one sensor, or more than the two sensors shown here, can be connected to processor 1. Sensors 3 and 4 can be of the same type or different types.

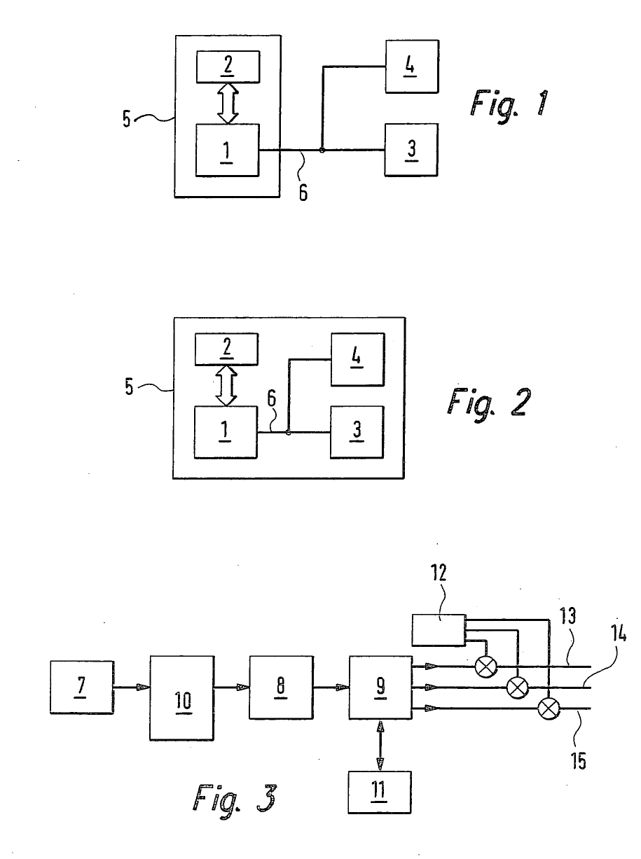

FIG. 2 shows a second basic configuration of control unit 5 and sensors 3 and 4. In this case, sensors 3 and 4 are located inside control unit 5 and are connected to processor 1 via data line 6, which serves to transfer the central clock cycle from processor 1. A combination of the configurations in FIG. 1 and FIG. 2 is possible as well, whereby sensors can be located inside control unit 5 and outside of control unit 5.

FIG. 3 shows, in the form of a block diagram, how the means for clock-cycle generation in processor 1 operate. An oscillation generation circuit 7 serves to generate an oscillation, the oscillation being multiplied in terms of frequency by a phase-locked loop 10 that is combined with an oscillator. An analog-digital converter 8 then digitizes the frequency-multiplied signal. A prescaler 9, using registers 11 and an internal logic, derives the individual clock cycles for the sensors. The keying ratios are stored in registers 11 for this purpose, into which said keying ratios the frequency-multiplied frequency must be divided to generate the three individual clock cycles that must be generated here.

A component 12 ensures that the three individual clock cycles are provided with a particular level that is required for pick-up by the sensors. Three clock cycles 13, 14 and 15 are then available at the output of these means for clock-cycle generation.

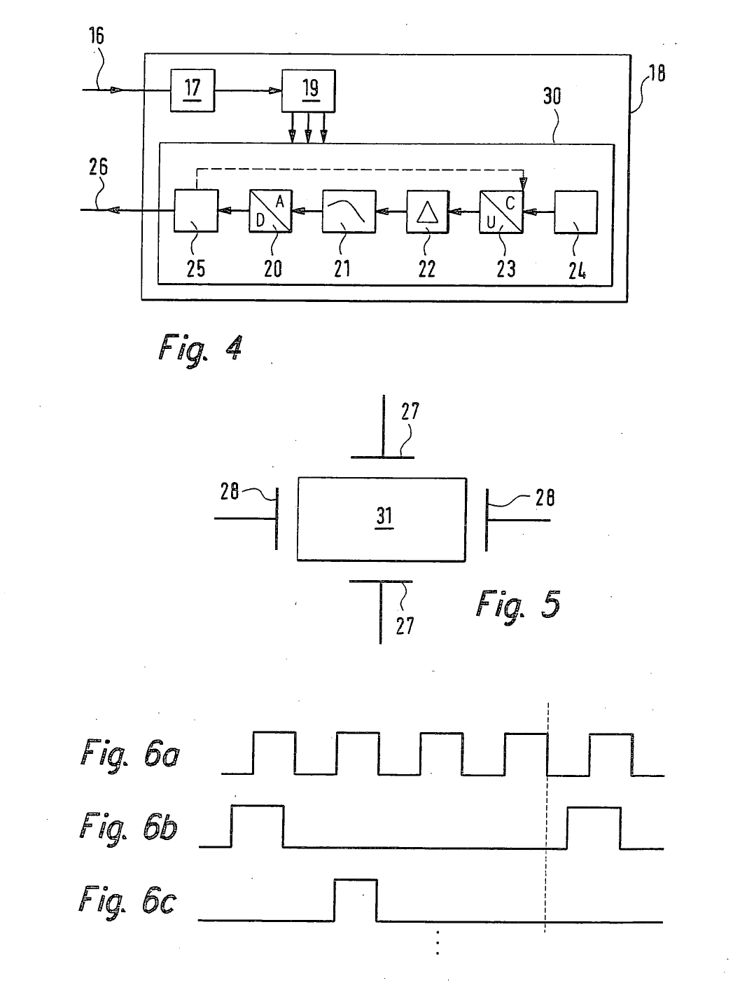

In FIG. 4, a block diagram is used to depict how a sensor 18 picks up a timing signal 16 and therefore carries out the processing of the sensor signal. Timing signal 16 is received by a receive module 17 in the sensor and forwarded to a component 19 that derives a corresponding clock cycle therefrom and performs phase mode generation, i.e., only the respective first, second, third or fourth timing signal is used for certain applications. The timing signals are supplied to the measuring sequence 30 sensor element 24 (e.g., micromechanical spring-mass system for measuring acceleration), charge-voltage converter 23, measurement amplifier 22, filter 21, analog-digital converter 20 and logic component 25 (offset regulation, further preprocessing), where they are used in different fashions as time base, e.g., for sampling and converting procedures, or as modulation signals. The signal at the end of the measuring sequence is then transferred as an analog or digital signal to processor 1 via line(s) 26.

FIG. 5 shows schematically that a seismic mass 31 is surrounded by electrodes 27 and 28, to record accelerations in the x-y plane, e.g., via a change in capacitance. Phase mode generation is needed for this purpose. FIG. 6 shows this phase mode generation. Timing signal A received by component 19 shows four clock pulses in this case. The phase mode generation generated a first signal B, however, with which only the first clock pulse is used, and a signal C, with which only the second clock pulse is used. One or more clock cycles such as these are required to measure the capacitances of electrodes 27 and 28.

What is claimed is:

1. Control unit (5) in a vehicle with a processor (1), whereby the processor (1) is capable of being connected with at least one sensor (3, 4), whereby the processor (1) includes means (7 through 15) for generating at least one clock pulse for the at least one sensor (3, 4), whereby the at least one sensor (3, 4, 18) is designed such that the at least one sensor (3, 4, 18) uses the clock pulse for a sensor operation, preferably sensor measurement.

2. The control unit as recited in claim 1,
wherein the means (7 through 15) for generating the at least one clock pulse include an oscillation generation circuit (7), means (10) for frequency multiplication, and first means (9, 11) for pulse division.

3. The control unit as recited in claim 2,
wherein the oscillation generation circuit (7) includes a quartz oscillator or a ceramic capacitor.

4. The control unit as recited in claim 2,
wherein the means (10) for frequency multiplication include a phase-locked loop.

5. The control unit as recited in claim 2,
wherein the first means (9, 11) include a prescaler (9) for pulse division, the prescaler having at least one register (11), whereby the at least one register (11) has a particular dividing ratio.

6. The control unit as recited in claim 1,
wherein the processor includes means for providing different levels for the at least one clock pulse.

7. A sensor as recited in claim 1, wherein the at least one sensor (3, 4, 18) includes second means (19) for pulse division and phase mode generation, which serve to prepare timing signals inside the sensor.

8. The sensor as recited in claim 7,
wherein the sensor includes a synchronous digital interface.

9. The sensor as recited in claim 7,
wherein the sensor (3, 4) is located in the control unit (5).

10. The sensor as recited in claim 7, wherein the at least one sensor is capable of being connected with the processor (1) via a bus (6).

11. The sensor as recited in claim 7, wherein the sensor is configured as an acceleration sensor or a yaw-rate sensor.
